(19) United States
(12) Patent Application Publication
(10) Pub. No.: US 2021/0016801 A1
(43) Pub. Date: Jan. 21, 2021

(54) VEHICLE CONTROLLER DEVICE AND VEHICLE CONTROL SYSTEM

(71) Applicant: TOYOTA JIDOSHA KABUSHIKI KAISHA, Toyota-shi (JP)

(72) Inventors: Yasuki NAKAGAWA, Toyota-shi (JP); Atsushi HANAWA, Miyoshi-shi (JP); Makoto MATSUSHITA, Ichinomiya-shi (JP); Yusuke YOKOTA, Susono-shi (JP); Tomoyuki KURIYAMA, Hadano-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 16/910,216

(22) Filed: Jun. 24, 2020

(30) Foreign Application Priority Data
Jul. 16, 2019 (JP) 2019-131387

(51) Int. Cl. B60W 60/00; G05D 1/00; G01C 21/34; G08G 1/00

(52) U.S. Cl. CPC B60W 60/0025; G05D 1/0011; G08G 1/22; B60W 60/005; G01C 21/3407

(57) ABSTRACT

vehicle controller device including: a communication section that is configured to communicate with an operation device external to a vehicle and with another vehicle; a processor being configured to: acquire peripheral information regarding a periphery of the vehicle; generate a travel plan for the vehicle based on the peripheral information of the vehicle; hand over operation authority to the operation device in a case in which a priority vehicle capable of taking priority over the vehicle when traveling on a road approaches the vehicle; acquire remote operation information to operate the vehicle, from the operation device to which operation authority has been handed over; control autonomous driving in which the vehicle travels based on the generated travel plan and also control remote driving in which the vehicle travels based on the acquired remote operation information; and output other-vehicle operation information to operate the other vehicle during remote driving.

### CROSS-REFERENCE TO RELATED APPLICATION

This application is based on and claims priority under 35 USC 119 from Japanese Patent Application No. 2019-131387 filed on Jul. 16, 2019, the disclosure of which is incorporated by reference herein.

### BACKGROUND

### Technical Field

The present disclosure relates to a vehicle controller device capable of implementing autonomous driving and remote driving, and a vehicle control system including such a vehicle controller device.

### Related Art

Japanese Patent Application Laid-Open (JP-A) No. 2018-151208 discloses an autonomous driving support device that enables a vehicle traveling by autonomous driving to perform an evasive maneuver for an emergency vehicle. In this autonomous driving support device, when an emergency vehicle approaching a given vehicle is detected while the vehicle is traveling by autonomous driving, a state of a driver of the vehicle is detected in order to determine whether or not it is possible to switch from an autonomous driving mode to a manual driving mode in which driving operation is performed by the driver. In cases in which the approach of an emergency vehicle has been detected and a switch to the manual driving mode is judged not to be possible, the autonomous driving support device alters a travel route of the given vehicle to a travel route that does not coincide with a travel route acquired from the emergency vehicle.

The autonomous driving support device of JP-A No. 2018-151208 is also capable of performing remote driving using a remote operator located externally to the vehicle. Accordingly, by switching from autonomous driving to remote driving in cases in which the approach of a priority vehicle such as an emergency vehicle has been detected and a switch to the manual driving mode is judged not to be possible, the autonomous driving support device is able to perform an evasive maneuver for the priority vehicle. However, in cases in which plural remotely driven vehicles are present on the travel route of the priority vehicle, there may be insufficient remote operator availability if every vehicle requires a remote operator.

Moreover, if remote operators of each of the vehicles were to perform different evasive maneuvers, speedy travel of the priority vehicle may be impeded.

### SUMMARY

An object of the present disclosure is to provide a vehicle controller device and a vehicle control system enabling a single remote operator to perform an evasive maneuver collectively for plural vehicles when a priority vehicle approaches.

A first aspect is a vehicle controller device including a communication section that is configured to communicate with an operation device external to a vehicle and with another vehicle, a peripheral information acquisition section configured to acquire peripheral information regarding a periphery of the vehicle from a peripheral information detection section, a travel plan generation section configured to generate a travel plan for the vehicle based on the peripheral information of the vehicle, a handover section configured to hand over operation authority to the operation device in a case in which a priority vehicle capable of taking priority over the vehicle when traveling on a road approaches the vehicle, an operation information acquisition section configured to acquire remote operation information for a remote operator to operate the vehicle, from the operation device to which operation authority has been handed over, a travel control section configured to control autonomous driving in which the vehicle travels based on the travel plan generated by the travel plan generation section and also control remote driving in which the vehicle travels based on the remote operation information acquired by the operation information acquisition section, and an information output section configured to output other-vehicle operation information for the remote operator to operate the other vehicle during remote driving.

In the vehicle controller device of the first aspect, the travel control section is capable of implementing both autonomous driving and remote driving. The autonomous driving is implemented based on the peripheral information acquired from the peripheral information detection section by the peripheral information acquisition section, and the travel plan generated by the travel plan generation section. The remote driving is implemented based on remote operation information transmitted from the operation device and received by the communication section. In cases in which a priority vehicle approaches the vehicle, the handover section of the vehicle controller device hands over operation authority of the vehicle to the operation device, and the operation information acquisition section acquires the remote operation information from the operation device. The travel control section then starts remote driving based on the remote operation information acquired from the operation device, and the information output section outputs the other-vehicle operation information to the other vehicle in order to operate the other vehicle. The remote operator of the vehicle is thus able to remotely drive the other vehicle that has received the other-vehicle operation information through the vehicle controller device. The vehicle controller device thus enables a single remote operator to perform an evasive maneuver collectively for plural vehicles when a priority vehicle approaches.

A vehicle controller device of a second aspect is the vehicle controller device of the first aspect, wherein the communication section is configured to receive the remote operation information from the operation device via the other vehicle.

In the vehicle controller device of the second aspect, since the communication section is capable of receiving the remote operation information via the other vehicle, remote driving can be continued even in cases in which communication between the operation device and the vehicle controller device has not been established due to a communication problem or the like.

A vehicle controller device of a third aspect is the vehicle controller device of either the first aspect or the second aspect, wherein the communication section is configured to receive approach notification information transmitted from the priority vehicle, and the handover section is further configured to judge approaching of the priority vehicle based on the approach notification information received by the communication section.

In the vehicle controller device of the third aspect, approaching of the priority vehicle is judged based on the approach notification information transmitted by the priority vehicle. This enables switching to remote driving to be started before the priority vehicle comes within visual range.

A fourth aspect is a vehicle control system including the vehicle controller device of any one of the first aspect to the third aspect, the vehicle, installed with the vehicle controller device, and one or more other vehicles, also installed with a vehicle controller device and drivable based on the other-vehicle operation information.

In the vehicle control system of the fourth aspect, since each vehicle on a route traveled by the priority vehicle is installed with the vehicle controller device, a single remote operator is able to perform an evasive maneuver collectively for plural vehicles when a priority vehicle approaches.

The present disclosure enables a single remote operator to perform an evasive maneuver collectively for plural vehicles when an emergency vehicle approaches.

### BRIEF DESCRIPTION OF THE DRAWINGS

Exemplary embodiments of the present disclosure will be described in detail based on the following figures, wherein:

FIG. 1 is a diagram illustrating a schematic configuration of a vehicle control system according to a first exemplary embodiment;

FIG. 2 is a block diagram illustrating hardware configuration of an autonomous driving-enabled vehicle of the first exemplary embodiment;

FIG. 3 is a block diagram illustrating an example of functional configuration of a vehicle controller device of the first exemplary embodiment;

FIG. 4 is a block diagram illustrating hardware configuration of a remote operation station of the first exemplary embodiment;

FIG. 5 is a block diagram illustrating an example of functional configuration of a remote controller device of the first exemplary embodiment;

FIG. 6 is a flowchart to explain a flow of vehicle detection processing of the first exemplary embodiment;

FIG. 7 is a sequence diagram to explain a flow of processing between respective devices during approach of an emergency vehicle in the first exemplary embodiment;

FIG. 8A is a diagram illustrating an example of travel states of a given vehicle and leading vehicles in a situation in which an emergency vehicle has approached in the first exemplary embodiment;

FIG. 8B is a diagram illustrating an example of travel states of a given vehicle and leading vehicles in a situation in which an emergency vehicle is passing in the first exemplary embodiment;

FIG. 9 is a sequence diagram to explain a flow of processing between respective devices during passage of an emergency vehicle in the first exemplary embodiment; and

FIG. 10 is a sequence diagram to explain a flow of processing between respective devices in a second exemplary embodiment.

### DETAILED DESCRIPTION

### First Exemplary Embodiment

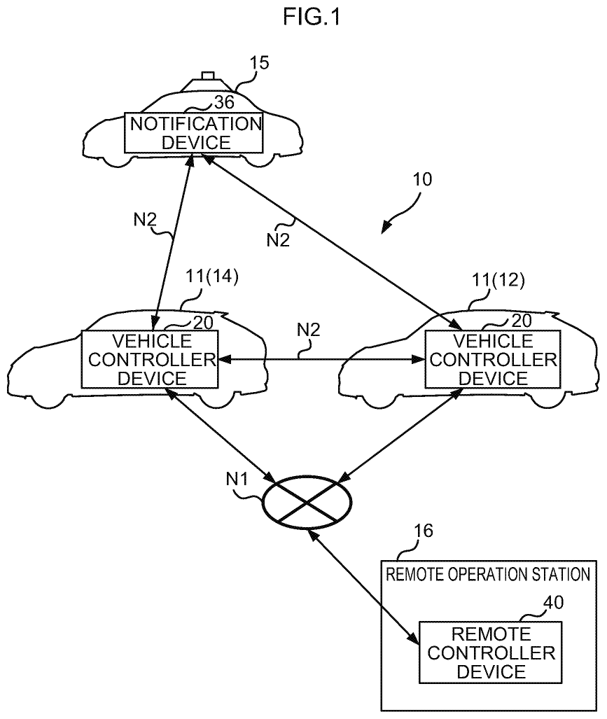

FIG. 1 is a block diagram illustrating schematic configuration of a vehicle control system 10 according to a first exemplary embodiment.

Outline

As illustrated in FIG. 1, the vehicle control system 10 according to the first exemplary embodiment includes autonomous driving-enabled vehicles 11, and a remote operation station 16 serving as an operation device. The autonomous driving-enabled vehicles 11 of the present exemplary embodiment include a given vehicle 12, serving as a vehicle, and a leading vehicle 14 serving as another vehicle.

The given vehicle 12 and the leading vehicles 14 of the present exemplary embodiment each include a vehicle controller device 20. The remote operation station 16 includes a remote controller device 40. The vehicle controller device 20 of the given vehicle 12, the vehicle controller devices 20 of the leading vehicles 14, and the remote controller device 40 of the remote operation station 16 in the vehicle control system 10 are connected together through a network N1. The respective vehicle controller devices 20 are also capable of communicating with each other directly using inter-vehicle communication N2. Moreover, each of the vehicle controller devices 20 are capable of using the inter-vehicle communication N2 to communicate directly with an emergency vehicle 15 that is equipped with a notification device 36. The emergency vehicle 15 corresponds to a priority vehicle permitted to take priority over the given vehicle 12 and the leading vehicle 14 when traveling on a road. Examples of priority vehicles include legally defined emergency vehicles such as police cars, fire trucks, and ambulances, as well as disaster response vehicles dispatched in the event of a disaster, buses, streetcars that run on tracks on the road, and other preassigned vehicles that have priority when traveling on a road.

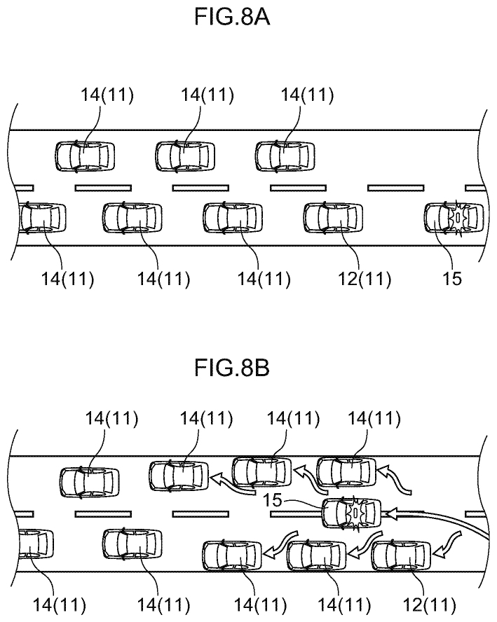

Although the vehicle control system 10 in FIG. 1 is configured by two of the autonomous driving-enabled vehicles 11 (the given vehicle 12 and the leading vehicle 14) and the one remote operation station 16, the numbers of each are not limited thereto. The vehicle control system 10 may include three or more of the autonomous driving-enabled vehicles 11, and may include two or more of the remote operation stations 16. In the present exemplary embodiment, the given vehicle 12 corresponds to the last in line out of a group of vehicles traveling on a road, and the leading vehicle 14 corresponds to any vehicle traveling ahead of the given vehicle 12 in the set of vehicles traveling on the road (see FIG. 8A).

The vehicle controller device 20 of the given vehicle 12 is capable of implementing autonomous driving in which the given vehicle 12 travels independently based on a pre-generated travel plan, remote driving based on operation by a remote driver at the remote operation station 16, and manual driving based on operation by an occupant (namely, a driver) of the given vehicle 12. Note that the leading vehicle 14 is also capable of implementing autonomous driving by the vehicle controller device 20, remote driving, and manual driving, similarly to the given vehicle 12.

Autonomous Driving-Enabled Vehicle

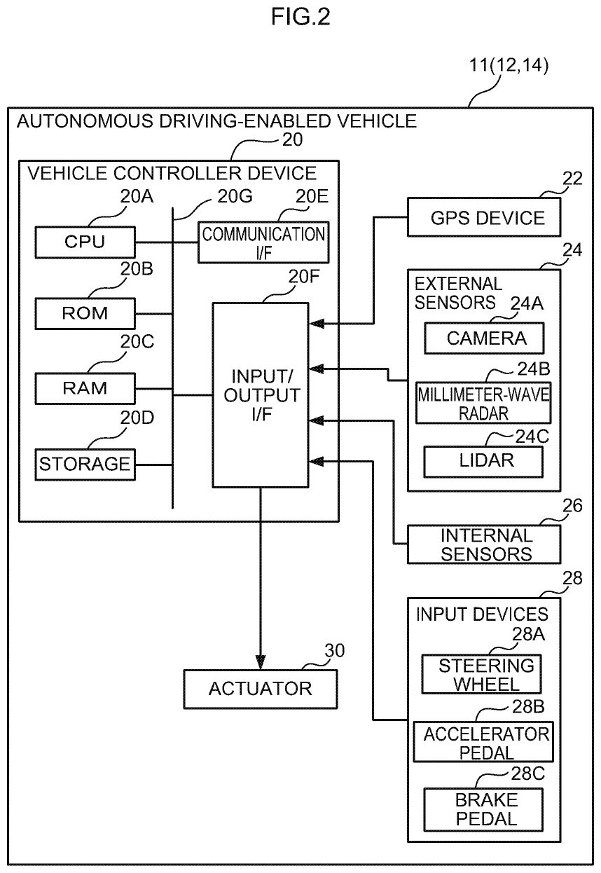

FIG. 2 is a block diagram illustrating hardware configuration of equipment installed to each of the autonomous driving-enabled vehicles 11 of the present exemplary embodiment. Note that since the given vehicle 12 and the leading vehicle 14 configuring the autonomous driving-enabled vehicles 11 of the present exemplary embodiment have similar configurations to each other, only the given vehicle 12 will be explained herein. In addition to the vehicle controller device 20 described above, the given vehicle 12 also includes a global positioning system (GPS) device 22, external sensors 24, internal sensors 26, input devices 28, and actuators 30.

The vehicle controller device 20 is configured including a central processing unit (CPU) 20A, read only memory (ROM) 20B, random access memory (RAM) 20C, storage 20D, a communication interface (I/F) 20E, and an input/output I/F 20F. The CPU 20A, the ROM 20B, the RAM 20C, the storage 20D, the communication I/F 20E and the input/output OF 20F are connected together so as to be capable of communicating with each other through a bus 20G. The CPU 20A is an example of a first processor, and the RAM 20C is an example of first memory.

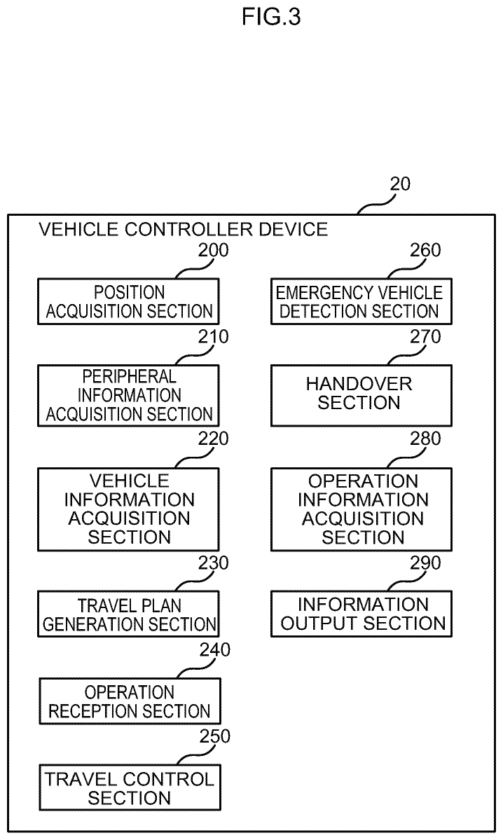

The CPU 20A is a central processing unit that executes various programs and controls various sections. Namely, the CPU 20A reads a program from the ROM 20B and executes the program, using the RAM 20C as a workspace. In the present exemplary embodiment, an execution program is stored in the ROM 20B. When the CPU 20A executes the execution program, the vehicle controller device 20 functions as a position acquisition section 200, a peripheral information acquisition section 210, a vehicle information acquisition section 220, a travel plan generation section 230, an operation reception section 240, a travel control section 250, an emergency vehicle detection section 260, a handover section 270, an operation information acquisition section 280, and an information output section 290, as illustrated in FIG. 3.

As illustrated in FIG. 2, the ROM 20B stores various programs and various data. The RAM 20C serves as a workspace to temporarily store the programs or data.

The storage 20D serves as a storage section, is configured by a hard disk drive (HDD) or a solid state drive (SSD), and stores various programs including an operating system, as well as various data.

The communication I/F 20E serves as a communication section, and includes an interface for connecting to the network N1 in order to communicate with other vehicle controller devices 20, the remote controller device 40, and the like. A communication protocol such as LTE or Wi-Fi (registered trademark) is employed as the interface. Moreover, the communication I/F 20E includes a wireless device to communicate directly with the other vehicle controller devices 20 and a notification device 36 using the inter-vehicle communication N2, employing dedicated short range communications (DSRC) or the like.

The communication I/F 20E of the present exemplary embodiment transmits an image captured by a camera 24A to the remote operation station 16 that is external to the given vehicle 12, and receives remote operation information, this being operation information to operate the given vehicle 12, from the remote operation station 16 through the network N1. The communication I/F 20E also transmits other-vehicle operation information, this being operation information to operate the leading vehicle 14, to the leading vehicle 14 using the inter-vehicle communication N2.

The input/output I/F 20F is an interface for communicating with the various devices installed in the given vehicle 12. The vehicle controller device 20 of the present exemplary embodiment is connected to the GPS device 22, the external sensors 24, the internal sensors 26, the input devices 28, and the actuators 30 through the input/output I/F 20F. Note that the GPS device 22, the external sensors 24, the internal sensors 26, the input devices 28, and the actuators 30 may be directly connected to the bus 20G.

The GPS device 22 is a device for measuring the current position of the given vehicle 12. The GPS device 22 includes an antenna to receive signals from GPS satellites.

The external sensors 24 serve as a peripheral information detection section, and are a group of sensors that detect peripheral information from the periphery of the given vehicle 12. The external sensors 24 include the camera 24A that images a predetermined range, millimeter-wave radar 24B that transmits scanning waves over a predetermined range and receives the reflected waves, and laser imaging detection and ranging (LIDAR) 24C that scans a predetermined range.

The internal sensors 26 are a group of sensors that detect travel states of the given vehicle 12. The internal sensors 26 include at least one out of a vehicle speed sensor, an acceleration sensor, and a yaw rate sensor.

The input devices 28 are a group of switches operated by the occupant on board the given vehicle 12. The input devices 28 include a steering wheel 28A serving as a switch to steer the steered wheels of the given vehicle 12, an accelerator pedal 28B serving as a switch to cause the given vehicle 12 to accelerate, and a brake pedal 28C serving as a switch to cause the given vehicle 12 to decelerate.

The actuators 30 include a steering wheel actuator to drive the steered wheels of the given vehicle 12, an accelerator actuator to control acceleration of the given vehicle 12, and a brake actuator to control deceleration of the given vehicle 12.

FIG. 3 is a block diagram illustrating an example of functional configuration of the vehicle controller device 20. As illustrated in FIG. 3, the vehicle controller device 20 includes the position acquisition section 200, the peripheral information acquisition section 210, the vehicle information acquisition section 220, the travel plan generation section 230, the operation reception section 240, the travel control section 250, the emergency vehicle detection section 260, the handover section 270, the operation information acquisition section 280, and the information output section 290. Each of these functional configurations is implemented by the CPU 20A reading the execution program stored in the ROM 20B, and executing this program.

The position acquisition section 200 includes functionality to acquire the current position of the given vehicle 12. The position acquisition section 200 acquires position information from the GPS device 22 through the input/output I/F 20F.

The peripheral information acquisition section 210 includes functionality to acquire peripheral information from the periphery of the given vehicle 12. The peripheral information acquisition section 210 acquires peripheral information regarding the given vehicle 12 from the external sensors 24 through the input/output I/F 20F. The “peripheral information” includes not only information regarding vehicles and pedestrians in the surroundings of the given vehicle 12, but also information regarding the weather, brightness, road width, obstacles, and so on.

The vehicle information acquisition section 220 includes functionality to acquire vehicle information such as the vehicle speed, acceleration, yaw rate, and so on of the given vehicle 12. The vehicle information acquisition section 220 acquires the vehicle information regarding the given vehicle 12 from the internal sensors 26 through the input/output I/F 20F.

The travel plan generation section 230 includes functionality to generate a travel plan to cause the given vehicle 12 to travel based on the position information acquired by the position acquisition section 200, the peripheral information acquired by the peripheral information acquisition section 210, and the vehicle information acquired by the vehicle information acquisition section 220. The travel plan includes not only a travel route to a pre-set destination, but also information regarding a course to avoid obstacles ahead of the given vehicle 12, the speed of the given vehicle 12, and so on.

The operation reception section 240 includes functionality to receive signals output from the various input devices 28 when manual driving is being performed based on operation by the occupant of the given vehicle 12. The operation reception section 240 also generates vehicle operation information, this being operation information to control the actuators 30, based on signals received from the various input devices 28.

The travel control section 250 includes functionality to control autonomous driving based on the travel plan generated by the travel plan generation section 230, remote driving based on the remote operation information received from the remote operation station 16, and manual driving based on the vehicle operation information received from the operation reception section 240. Moreover, the travel control section 250 of the vehicle controller device 20 in the leading vehicle 14 performs autonomous driving based on the other-vehicle operation information received from the vehicle controller device 20 of the given vehicle 12 and the peripheral information of the leading vehicle 14.

The emergency vehicle detection section 260 includes functionality to detect the emergency vehicle 15. Specifically, the emergency vehicle detection section 260 detects the emergency vehicle 15 in cases in which the emergency vehicle 15 is included in an image captured by the camera 24A and acquired by the peripheral information acquisition section 210. The emergency vehicle detection section 260 also detects the emergency vehicle 15 in cases in which approach notification information transmitted from the emergency vehicle 15 has been acquired through the communication I/F 20E.

The handover section 270 includes functionality to hand over operation authority, this being authority to operate the autonomous driving-enabled vehicles 11 to which the vehicle controller device 20 is installed, to the remote operation station 16. The handover section 270 transmits an authority transfer command to the remote operation station 16 in order to confer operation authority of the given vehicle 12 on the remote operation station 16. When operation authority of the given vehicle 12 has been transferred to the remote operation station 16, the travel control section 250 of the given vehicle 12 performs remote driving of the given vehicle 12 based on remote operation information received from the remote operation station 16. Moreover, the handover section 270 also transmits an authority transfer command to the remote operation station 16 in order to confer operation authority of the leading vehicle 14 on the remote operation station 16. When operation authority of the leading vehicle 14 is transferred to the remote operation station 16, the travel control section 250 of the leading vehicle 14 performs autonomous driving of the leading vehicle 14 based on the other-vehicle operation information received from the vehicle controller device 20 of the given vehicle 12.

The operation information acquisition section 280 includes functionality to acquire remote operation information from the remote operation station 16 in order to operate the given vehicle 12. More specifically, the operation information acquisition section 280 acquires remote operation information transmitted from the remote operation station 16 when operation authority has been transferred to the remote operation station 16.

The information output section 290 includes functionality to output approach detection information indicating the approach of the emergency vehicle 15, and other-vehicle operation information to operate the leading vehicle 14, to the leading vehicle 14. Specifically, when the emergency vehicle detection section 260 has detected the emergency vehicle 15, the information output section 290 transmits approach detection information to the vehicle controller device 20 of the leading vehicle 14 through the communication I/F 20E. The information output section 290 also generates other-vehicle operation information based on remote operation information relating to remote operation by a remote driver, acquired by the operation information acquisition section 280, and transmits this other-vehicle operation information to the vehicle controller device 20 of the leading vehicle 14 through the communication I/F 20E. The vehicle controller device 20 of the leading vehicle 14 performs autonomous driving based on the other-vehicle operation information and peripheral information of the leading vehicle 14.

Note that the other-vehicle operation information of the present exemplary embodiment differs from remote operation information used to control the actuators 30 directly, in that it is information used to modify a travel plan. For example, the other-vehicle operation information includes course information to move the leading vehicle 14 over to the roadside and speed information to reduce the speed of the leading vehicle 14.

Remote Operation Station

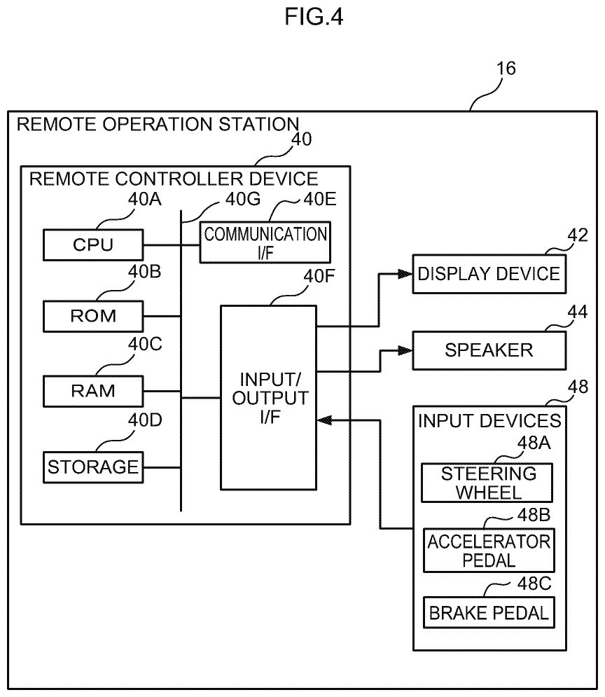

FIG. 4 is a block diagram illustrating hardware configuration of equipment installed in the remote operation station 16 of the present exemplary embodiment. In addition to the remote controller device 40 previously described, the remote operation station 16 also includes a display device 42, a speaker 44, and input devices 48.

The remote controller device 40 is configured including a CPU 40A, ROM 40B, RAM 40C, storage 40D, a communication I/F 40E and an input/output I/F 40F. The CPU 40A, the ROM 40B, the RAM 40C, the storage 40D, the communication I/F 40E, and the input/output I/F 40F are connected together so as to be capable of communicating with each other through a bus 40G. Functionality of the CPU 40A, the ROM 40B, the RAM 40C, the storage 40D, the communication I/F 40E, and the input/output I/F 40F matches that of the CPU 20A, the ROM 20B, the RAM 20C, the storage 20D, the communication I/F 20E, and the input/output I/F 20F of the vehicle controller device 20 previously described. The CPU 40A is an example of a second processor, and the RAM 40C is an example of second memory.

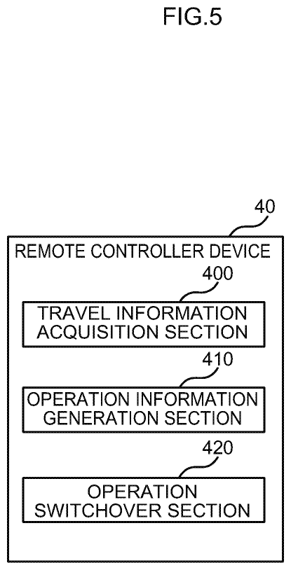

The CPU 40A reads a program from the ROM 40B and executes the program, using the RAM 40C as a workspace. In the present exemplary embodiment, a processing program is stored in the ROM 40B. When the CPU 40A executes the processing program, the remote controller device 40 functions as a travel information acquisition section 400, an operation information generation section 410, and an operation switchover section 420 as illustrated in FIG. 5.

The display device 42, the speaker 44, and the input devices 48 are connected to the remote controller device 40 of the present exemplary embodiment through the input/output I/F 40F. Note that the display device 42, the speaker 44, and the input devices 48 may be directly connected to the bus 40G.

The display device 42 is a liquid crystal monitor for displaying an image captured by the camera 24A of the given vehicle 12 and various information relating to the given vehicle 12.

The speaker 44 is a speaker for replaying audio recorded by a microphone (not illustrated in the drawings) attached to the camera 24A of the given vehicle 12 together with the captured image.

The input devices 48 are controllers to be operated by the remote driver serving as a remote operator using the remote operation station 16. The input devices 48 include a steering wheel 48A serving as a switch to steer the steered wheels of the given vehicle 12, an accelerator pedal 48B serving as a switch to cause the given vehicle 12 to accelerate, and a brake pedal 48C serving as a switch to cause the given vehicle 12 to decelerate. Note that the implementation of the respective input devices 48 is not limited thereto. For example, a lever switch may be provided instead of the steering wheel 48A. As another example, push button switches or lever switches may be provided instead of the pedal switches of the accelerator pedal 48B or the brake pedal 48C.

FIG. 5 is a block diagram illustrating an example of functional configuration of the remote controller device 40. As illustrated in FIG. 5, the remote controller device 40 includes the travel information acquisition section 400, the operation information generation section 410, and the operation switchover section 420.

The travel information acquisition section 400 includes functionality to acquire audio as well as the images captured by the camera 24A and transmitted by the vehicle controller device 20, and also acquire vehicle information such as the vehicle speed. The acquired captured images and vehicle information are displayed on the display device 42, and the audio information is output through the speaker 44.

The operation information generation section 410 includes functionality to receive signals output from the various input devices 48 when remote driving is being performed based on operation by the remote driver. The operation information generation section 410 also generates remote operation information to be transmitted to the vehicle controller device 20 based on the signals received from the various input devices 48.

The operation switchover section 420 includes functionality to cause the vehicle controller device 20 to switch to remote driving or to implement autonomous driving based on the other-vehicle operation information. For example, in cases in which an authority transfer command has been received from the vehicle controller device 20 of the given vehicle 12, the operation switchover section 420 transmits a switchover command instructing the vehicle controller device 20 of the given vehicle 12 to switch to remote driving. The vehicle controller device 20 of the given vehicle 12 that receives the switchover command thus switches from autonomous driving or manual driving to remote driving. As another example, in cases in which the operation switchover section 420 has received an authority transfer command from the vehicle controller device 20 of the leading vehicle 14, the operation switchover section 420 transmits an operation intervention command instructing the vehicle controller device 20 of the leading vehicle 14 to implement autonomous driving based on the other-vehicle operation information. The vehicle controller device 20 of the leading vehicle 14 that receives the operation intervention command thus performs autonomous driving based on the other-vehicle operation information.

The operation switchover section 420 also includes functionality to execute selection processing, described later. The operation switchover section 420 of the present exemplary embodiment performs the selection processing to select the autonomous driving-enabled vehicle 11 traveling last in line (namely, the given vehicle 12) as an autonomous driving-enabled vehicle 11 to operate the leading vehicle 14.

Flow of Control

In the present exemplary embodiment, when the emergency vehicle 15 approaches from behind in a case in which the given vehicle 12 and plural of the leading vehicles 14 are travelling by autonomous driving (see FIG. 8A), the given vehicle 12 and the leading vehicles 14 perform control to implement remote driving.

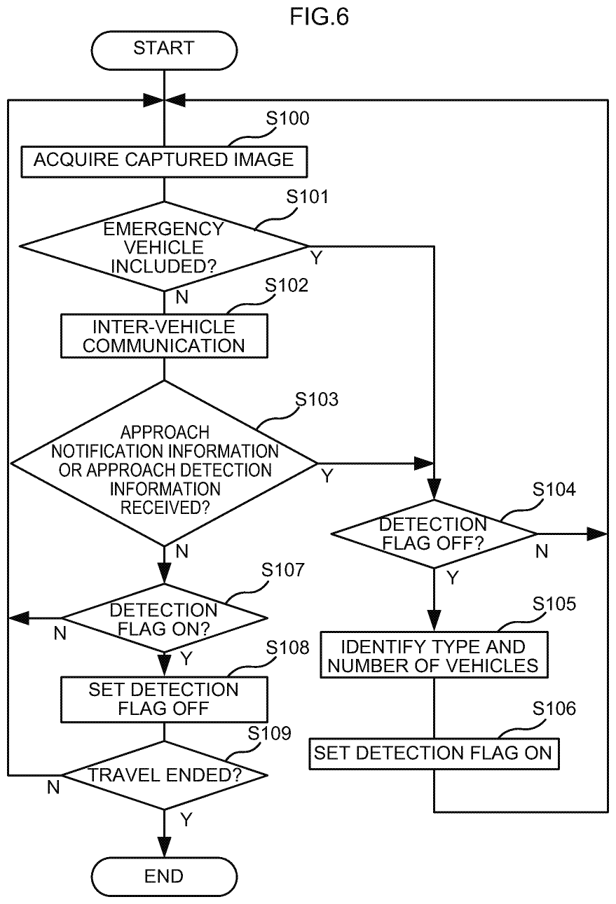

First, explanation follows regarding vehicle detection processing by which the vehicle controller devices 20 of the given vehicle 12 and the leading vehicles 14 detect the emergency vehicle 15, with reference to the flowchart of FIG. 6.

At step S100 in FIG. 6, the CPU 20A acquires a captured image from the camera 24A.

At step S101, the CPU 20A determines whether or not the emergency vehicle 15 is included in the acquired captured image. Processing proceeds to step S104 in cases in which the CPU 20A determines that the emergency vehicle 15 is included in the acquired captured image. Processing proceeds to step S102 in cases in which the CPU 20A determines that the emergency vehicle 15 is not included in the acquired captured image.

At step S102, the CPU 20A attempts inter-vehicle communication with vehicles traveling in the vicinity of the given vehicle 12.

At step S103, the CPU 20A determines whether or not approach notification information has been received from the emergency vehicle 15, or approach detection information has been received from another vehicle controller device 20. Processing proceeds to step S104 in cases in which approach notification information or approach detection information has been received by the CPU 20A. Processing proceeds to step S107 in cases in which approach notification information or approach detection information has not been received by the CPU 20A.

At step S104, the CPU 20A determines whether or not a detection flag indicating that the emergency vehicle 15 has been detected is OFF. Processing proceeds to step S105 in cases in which the CPU 20A determines that the detection flag is OFF. Processing returns to step S100 in cases in which the CPU 20A determines that the detection flag is not OFF, namely that the detection flag is ON.

At step S105, the CPU 20A identifies the type and number of the emergency vehicles 15. The type and number of the emergency vehicles 15 may be acquired from the approach notification information or the approach detection information.

At step S106, the CPU 20A sets the detection flag to ON. Processing then returns to step S100.

At step S107, the CPU 20A determines whether or not the detection flag is ON. Processing proceeds to step S108 in cases in which the CPU 20A determines that the detection flag is ON. Processing returns to step S100 in cases in which the CPU 20A determines that the detection flag is not ON, namely that the detection flag is OFF.

At step S108, the CPU 20A sets the detection flag to OFF.

At step S109, the CPU 20A determines whether or not travel has ended. The vehicle detection processing is ended in cases in which the CPU 20A determines that travel has ended. Processing returns to step S100 in cases in which the CPU 20A determines that travel has not ended, namely that travel is still continuing.

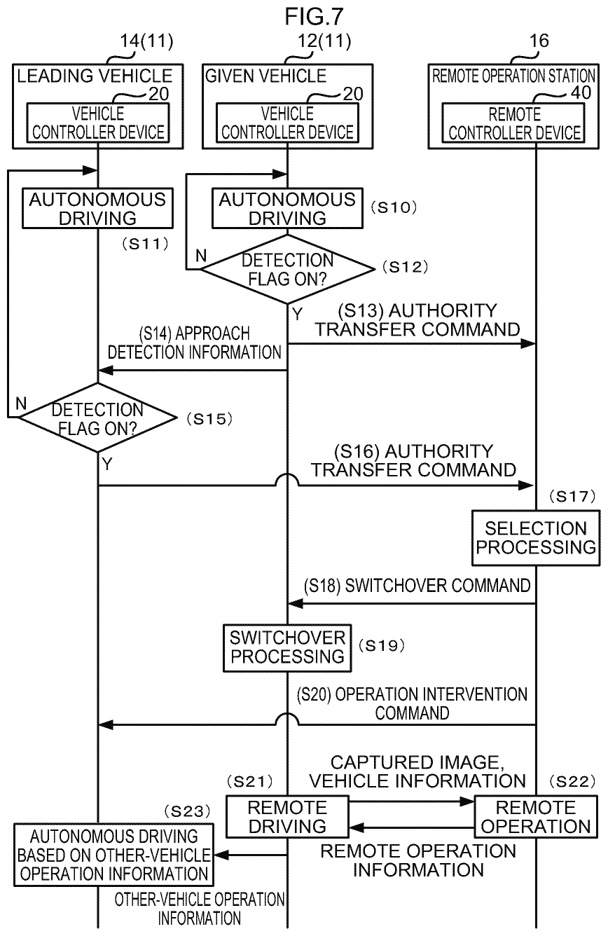

Explanation follows regarding a flow of processing by respective devices in a case in which the emergency vehicle 15 has approached the given vehicle 12 and a leading vehicle 14, with reference to the sequence diagram of FIG. 7.

At step S10 in FIG. 7, the CPU 20A of the vehicle controller device 20 in the given vehicle 12 is performing autonomous driving. At step S11, the CPU 20A of the vehicle controller device 20 in the leading vehicle 14 is also performing autonomous driving.

At step S12, the CPU 20A in the given vehicle 12 determines whether or not the detection flag is ON. Processing proceeds to step S13 in cases in which the CPU 20A determines that the detection flag is ON. Processing returns to step S10 in cases in which the CPU 20A determines that the detection flag is not ON, namely that the detection flag is OFF.

At step S13, the CPU 20A in the given vehicle 12 transmits an authority transfer command to the remote controller device 40 of the remote operation station 16.

At step S14, the CPU 20A in the given vehicle 12 transmits approach detection information indicating the approach of the emergency vehicle 15 to the vehicle controller device 20 of the leading vehicle 14.

At step S15, the CPU 20A in the leading vehicle 14 determines whether or not the detection flag is ON. Processing proceeds to step S16 in cases in which the CPU 20A determines that the detection flag is ON. Processing returns to step S11 in cases in which the CPU 20A determines that the detection flag is not ON, namely that the detection flag is OFF.

At step S16, the CPU 20A in the leading vehicle 14 transmits an authority transfer command to the remote controller device 40 of the remote operation station 16.

At step S17, the CPU 40A in the remote operation station 16 executes selection processing. In the selection processing of the present exemplary embodiment, the CPU 40A selects the autonomous driving-enabled vehicle 11 traveling last in line (namely, the given vehicle 12) as an autonomous driving-enabled vehicle 11 to operate the leading vehicle 14.

At step S18, the CPU 40A in the remote operation station 16 transmits a switchover command to the vehicle controller device 20 of the given vehicle 12 to instruct switchover to remote driving.

At step S19, the CPU 20A in the given vehicle 12 executes switchover processing. Namely, autonomous driving is switched to remote driving.

At step S20, the CPU 40A in the remote operation station 16 transmits an operation intervention command to the vehicle controller device 20 of the leading vehicle 14 to notify of an intervention to autonomous driving.

At step S21, the CPU 20A in the given vehicle 12 starts remote driving. At step S22, the CPU 40A in the remote operation station 16 starts remote operation. Namely, the remote operation station 16 receives an image captured by the camera 24A and vehicle information from the internal sensors 26 from the given vehicle 12, and transmits remote operation information to the vehicle controller device 20 of the given vehicle 12 to control the given vehicle 12.

At step S23, the CPU 20A in the leading vehicle 14 starts autonomous driving based on other-vehicle operation information. Namely, the leading vehicle 14 receives other-vehicle operation information to operate another vehicle from the vehicle controller device 20 of the given vehicle 12, and performs autonomous driving based on the other-vehicle operation information and peripheral information of the leading vehicle 14.

As described above, starting remote driving of the given vehicle 12 and autonomous driving of the leading vehicle 14 based on other-vehicle operation information enables the remote driver to perform evasive maneuvers to allow the emergency vehicle 15 to go ahead. Specifically, FIG. 8A envisages a case in which the emergency vehicle 15 is approaching the given vehicle 12 and the leading vehicles 14, which are traveling in procession on a road with two lanes in each direction. In this case, the given vehicle 12 traveling last in line in the left hand lane is moved over to the left edge of the road by remote operation by the remote driver at the remote operation station 16.

Moreover, the other-vehicle operation information is transmitted from the given vehicle 12 to the leading vehicles 14 in order to move the leading vehicles 14 over to the left edge or the right edge of the road according to the remote operation by the remote driver. When leading vehicles 14 traveling in the left hand lane receive the other-vehicle operation information, autonomous driving is performed to move over to the left edge of the road, and when leading vehicles 14 traveling in the right hand lane receive the other-vehicle operation information, autonomous driving is performed to move over to the right edge of the road. Accordingly, as illustrated in FIG. 8B, the emergency vehicle 15 travels along a center line between the two lanes of the road so as to overtake the given vehicle 12 and the leading vehicles 14.

Note that the vehicle controller device 20 of the given vehicle 12 is capable of generating the other-vehicle operation information based on the type and number of the emergency vehicles 15 as identified at step S105 of the vehicle detection processing (see FIG. 6). Accordingly, for example in a case in which plural fire trucks are to pass by in succession, the autonomous driving can be performed such that the time for which the leading vehicles 14 are held at the left edge of the road or the right edge of the road is extended according to the number of fire trucks.

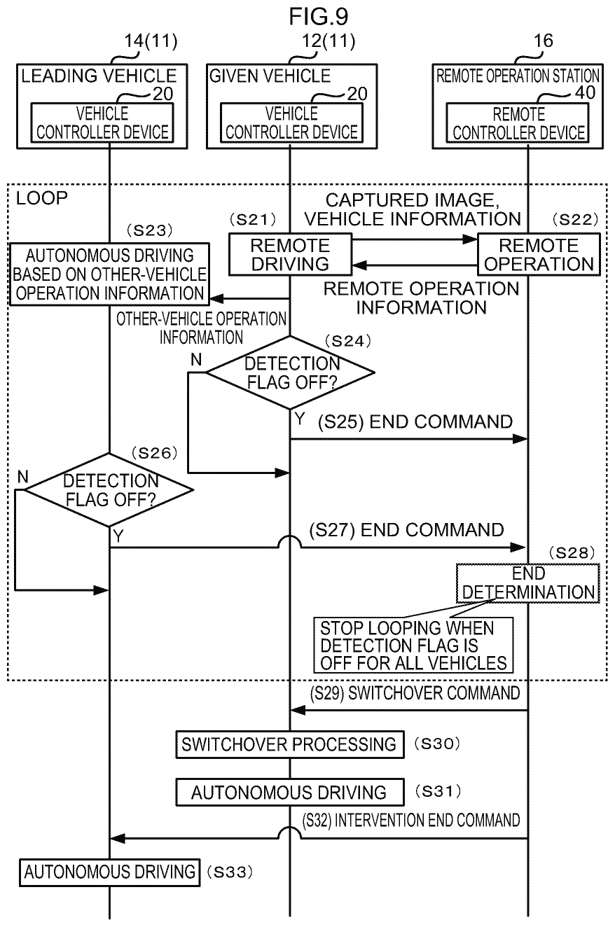

Next, explanation follows regarding a flow of processing between the respective devices after the emergency vehicle 15 has overtaken the given vehicle 12 and the leading vehicles 14, with reference to the sequence diagram of FIG. 9.

At step S24 in FIG. 9, the CPU 20A in the given vehicle 12 that is being remotely driven determines whether or not the detection flag is OFF. Processing proceeds to step S25 in cases in which the CPU 20A determines that the detection flag is OFF. The processing of step S25 is skipped in cases in which the CPU 20A determines that the detection flag is not OFF, namely that the detection flag is ON.

At step S25, the CPU 20A in the given vehicle 12 transmits an end command to the remote controller device 40 of the remote operation station 16 in order to end remote operation.

At step S26, the CPU 20A in the leading vehicle 14 that is being autonomously driven based on the other-vehicle operation information determines whether or not the detection flag is OFF. Processing proceeds to step S27 in cases in which the CPU 20A determines that the detection flag is OFF. The processing of step S27 is skipped in cases in which the CPU 20A determines that the detection flag is not OFF, namely that the detection flag is ON.

At step S27, the CPU 20A in the leading vehicle 14 transmits an end command to the remote controller device 40 of the remote operation station 16 to end the autonomous driving based on the other-vehicle operation information.

At step S28, the CPU 40A in the remote operation station 16 performs end determination. Processing proceeds to step S29 in cases in which the end determination result is that the detection flags are OFF in both the given vehicle 12 and the leading vehicle 14 to which the given vehicle 12 was transmitting the other-vehicle operation information. The processing of step S21 to step S28 is repeated in cases in which the detection flags are not OFF in both the given vehicle 12 and the leading vehicle 14.

At step S29, the CPU 40A in the remote operation station 16 transmits a switchover command to the vehicle controller device 20 of the given vehicle 12 to instruct a switch over to autonomous driving.

At step S30, to the CPU 20A in the given vehicle 12 executes switchover processing. Namely, the remote driving is switched to autonomous driving.

At step S31, the CPU 20A of the vehicle controller device 20 of the given vehicle 12 resumes autonomous driving.

At step S32, the CPU 40A in the remote operation station 16 transmits an intervention end command to the vehicle controller device 20 of the leading vehicle 14 to notify that the intervention to autonomous driving has ended.

At step S33, the CPU 20A of the vehicle controller device 20 of the leading vehicle 14 resumes independent autonomous driving.

### Summary of the First Exemplary Embodiment

If driving were to be left to the discretion of individual vehicles as the emergency vehicle 15 approaches, were the respective vehicles make different decisions with the result that, for example, some cars stop at the roadside while over vehicles drive slowly at the center of their lane, the emergency vehicle 15 may not be able to travel smoothly. By contrast, in the present exemplary embodiment, when the emergency vehicle 15 approaches, a remote driver is able to remotely drive one vehicle in a procession of vehicles in order to cause other vehicles in the procession to drive in a similar manner.

In the present exemplary embodiment, a single remote driver is able to operate plural vehicles collectively in order to perform an evasive maneuver when the emergency vehicle 15 approaches. The emergency vehicle 15 can thus be allowed to pass smoothly.

### Second Exemplary Embodiment

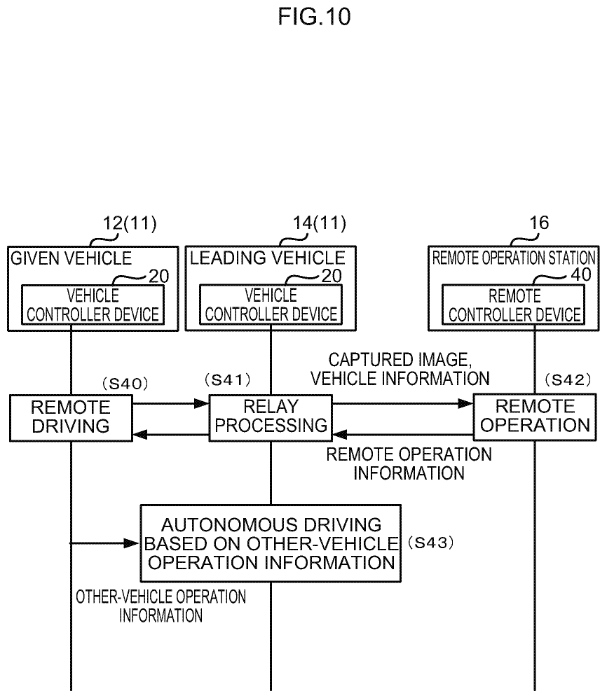

In the first exemplary embodiment, remote operation information is transmitted from the remote controller device 40 of the remote operation station 16 to the vehicle controller device 20 of the given vehicle 12. By contrast, in a second exemplary embodiment, configuration is made such that remote operation information is transmitted via the vehicle controller device 20 of a leading vehicle 14 in cases in which communication problems have arisen between the remote controller device 40 and the vehicle controller device 20 of the given vehicle 12. Explanation follows regarding a flow of processing between the respective devices in the second exemplary embodiment, with reference to the sequence diagram of FIG. 10.

In the present exemplary embodiment, the processing of step S40 to step S43 described below is executed instead of the processing of step S21 to step S23 of the first exemplary embodiment. Note that the processing of step S24 of the first exemplary embodiment onward is executed following the processing of step S43.

At step S40, the CPU 20A in the given vehicle 12 starts remote driving. At step S42, the CPU 40A in the remote operation station 16 starts remote operation. When this is performed, the CPU 20A in the leading vehicle 14 executes relay processing to relay the information that is being communicated between the vehicle controller device 20 and the remote controller device 40 (step S41).

Namely, the remote operation station 16 receives the captured image from the camera 24A and the vehicle information from the internal sensors 26 of the given vehicle 12 via the vehicle controller device 20 of the leading vehicle 14. Moreover, the vehicle controller device 20 of the given vehicle 12 receives the remote operation information to control the given vehicle 12 from the remote controller device 40 via the vehicle controller device 20 of the leading vehicle 14.

At step S43, the CPU 20A in the leading vehicle 14 receives the other-vehicle operation information to operate the other vehicle from the vehicle controller device 20 of the given vehicle 12, and performs autonomous driving based on the other-vehicle operation information.

As described above, in the present exemplary embodiment communication can be secured via the vehicle controller device 20 of the leading vehicle 14 even in cases in which a communication problem has arisen between the vehicle controller device 20 of the given vehicle 12 and the remote controller device 40 of the remote operation station 16. Note that when the quality of communication between the vehicle controller device 20 of the given vehicle 12 and the remote controller device 40 improves, the relay processing employing the vehicle controller device 20 of the leading vehicle 14 may be ended to switch to direct communication between the vehicle controller device 20 of the given vehicle 12 and the remote controller device 40.

Notes

Although explanation has been given regarding examples in which the remote driver handling the given vehicle 12 serves as a remote operator performing remote operation in the exemplary embodiments described above, there is no limitation thereto. An operator issuing instructions relating to the course, speed, and the like of the given vehicle 12 may be present as a remote operator performing remote operation.

Although the vehicle controller device 20 detects the emergency vehicle 15 based on a captured image including the emergency vehicle 15 in the exemplary embodiments described above, the vehicle controller device 20 may also detect the emergency vehicle 15 based on received approach notification information transmitted from the emergency vehicle 15. Detecting the emergency vehicle 15 without relying on a captured image enables switching to remote driving to be started before the emergency vehicle 15 comes within visual range, and irrespective of the imaging conditions of the camera 24A (weather conditions, time of day, and so on).

Although explanation has been given regarding examples in which the given vehicle 12 and the leading vehicle 14 are overtaken by the emergency vehicle 15 in the exemplary embodiments described above, there is no limitation thereto. For example, the given vehicle 12 may be traveling at the head of a procession and detect an approaching emergency vehicle 15 in an oncoming traffic lane, and the given vehicle 12 may allow the emergency vehicle 15 to pass using remote driving and allow the emergency vehicle 15 to pass vehicles other than the given vehicle 12 (namely, following vehicles) using autonomous driving based on other-vehicle operation information.

Note that in the exemplary embodiments described above, the given vehicle 12 performs remote driving based on remote operation information acquired from the remote controller device 40, and the leading vehicle 14 performs autonomous driving based on the other-vehicle operation information generated by the information output section 290 of the vehicle controller device 20 of the given vehicle 12. However, in addition to the remote operation information, the other-vehicle operation information may also be generated by the operation information generation section 410 of the remote controller device 40. For example, envisage a case in which a remote driver operates the steering wheel 48A of the remote operation station 16 toward the left so as to move the given vehicle 12 over to the roadside. In such a case, remote operation information to operate the steering wheel actuator toward the left is generated for the given vehicle 12, and other-vehicle operation information to update the travel plan of the leading vehicle 14 so as to alter the course toward the left is generated for the leading vehicle 14. The remote controller device 40 then transmits the remote operation information to the vehicle controller device 20 of the given vehicle 12, and transmits the other-vehicle operation information to the vehicle controller device 20 of the leading vehicle 14 via the vehicle controller device 20 of the given vehicle 12. Such a configuration is capable of obtaining similar operation and advantageous effects to those of the exemplary embodiments described above.

Note that the various processing executed by the CPU 20A reading software (a program), and the various processing executed by the CPU 40A reading software (a program) in the exemplary embodiments described above may be executed by various processors other than CPUs. Examples of such processors include programmable logic devices (PLDs) such as field-programmable gate arrays (FPGAs) that have a circuit configuration that can be modified following manufacture, or dedicated electrical circuits, these being processors such as application specific integrated circuits (ASICs) that have a custom designed circuit configuration to execute specific processing. The various processing may be executed using one of these processors, or may be executed by a combination of two or more processors of the same type or different types to each other (for example a combination of plural FPGAs, or a combination of a CPU and an FPGA). A more specific example of a hardware structure of these various processors is electric circuitry combining circuit elements such as semiconductor elements.

The exemplary embodiments described above describe a format in which the programs are stored (installed) in advance on a non-transitory computer-readable recording medium. For example, the execution program employed by the vehicle controller device 20 of the autonomous driving-enabled vehicles 11 is stored in advance in the ROM 20B. The processing program employed by the remote controller device 40 of the remote operation station 16 is stored in advance in the ROM 40B. However, there is no limitation thereto, and the respective programs may be provided in a format recorded on a non-transitory recording medium such as compact disc read only memory (CD-ROM), digital versatile disc read only memory (DVD-ROM), or universal serial bus (USB) memory. Alternatively, the respective programs may be configured in a format to be downloaded from an external device through a network.

The flows of processing in the exemplary embodiments described above are given as examples, and unnecessary steps may be omitted, new steps added, and the processing sequences rearranged within a range not departing from the spirit thereof.

What is claimed is:

1. A vehicle controller device comprising:
a communication section that is configured to communicate with an operation device external to a vehicle and with another vehicle;
a memory; and
a processor that is coupled to the memory, the processor being configured to:
acquire peripheral information regarding a periphery of the vehicle from a peripheral information detection section;
generate a travel plan for the vehicle based on the peripheral information of the vehicle;
hand over operation authority to the operation device in a case in which a priority vehicle capable of taking priority over the vehicle when traveling on a road approaches the vehicle;
acquire remote operation information for a remote operator to operate the vehicle, from the operation device to which operation authority has been handed over;
control autonomous driving in which the vehicle travels based on the generated travel plan and also control remote driving in which the vehicle travels based on the acquired remote operation information; and
output other-vehicle operation information for the remote operator to operate the other vehicle during remote driving.

2. The vehicle controller device of claim 1, wherein the processor is further configured to, based on the remote operation information, generate and output other-vehicle operation information to alter a travel plan of the other vehicle performing autonomous driving.

3. The vehicle controller device of claim 1, wherein the communication section is configured to receive the remote operation information from the operation device via the other vehicle.

4. The vehicle controller device of claim 1, wherein:
the communication section is configured to receive approach notification information transmitted from the priority vehicle; and
the processor is configured to judge approaching of the priority vehicle based on the approach notification information received by the communication section.

5. A vehicle control system comprising:
the vehicle controller device of claim 1;
the vehicle, installed with the vehicle controller device; and
one or more other vehicles, also installed with a vehicle controller device and drivable based on the other-vehicle operation information.

6. The vehicle control system of claim 5, wherein in a case in which the priority vehicle approaches the vehicle:
the processor at the vehicle hands over operation authority to the operation device and switches from the autonomous driving to the remote driving; and
a processor at another vehicle traveling in a vicinity of the vehicle performs autonomous driving based on the other-vehicle operation information.

7. The vehicle control system of claim 6, wherein in a case in which the priority vehicle has moved away from the vehicle and all of the one or more other vehicles receiving the other-vehicle operation information from the vehicle, the processor at the vehicle switches from the remote driving to the autonomous driving.

8. A vehicle control system comprising:
a vehicle controller device that is configured to control travel of a vehicle; and
an operation device that is external to the vehicle and that is configured to operate travel of the vehicle, wherein:
the vehicle controller device includes:
a communication section that is configured to communicate with the operation device and with another vehicle;
a first memory; and
a first processor that is coupled to the first memory, the first processor being configured to:
acquire peripheral information regarding a periphery of the vehicle from a peripheral information detection section,
generate a travel plan for the vehicle based on the peripheral information of the vehicle,
hand over operation authority to the operation device in a case in which a priority vehicle capable of taking priority over the vehicle when traveling on a road approaches the vehicle,
acquire remote operation information for a remote operator to operate the vehicle, from the operation device to which operation authority has been handed over, and
control autonomous driving in which the vehicle travels based on the generated travel plan and also control remote driving in which the vehicle travels based on the acquired remote operation information; and
the operation device includes:
a second memory, and
a second processor that is coupled to the second memory, the second processor being configured to generate the remote operation information, and also, based on the remote operation information, generate other-vehicle operation information to alter a travel plan of the other vehicle performing the autonomous driving.
